(19) United States
(12) Patent Application Publication
(10) Pub. No.: US 2025/0115454 A1
(43) Pub. Date: Apr. 10, 2025

(54) FILAMENT COILING DEVICE

(71) Applicant: JF POLYMERS (SUZHOU) CO., LTD., Suzhou (CN)

(72) Inventor: Guan LI, Suzhou (CN)

(73) Assignee: JF POLYMERS (SUZHOU) CO., LTD., Suzhou (CN)

(21) Appl. No.: 18/912,544

(22) Filed: Oct. 10, 2024

(30) Foreign Application Priority Data
Oct. 10, 2023 (CN) 2023113088490

(51) Int. Cl. B65H 54/44; B07C 5/18; B65H 65/00; B65H 67/06

(52) U.S. Cl. CPC B65H 54/44; B65H 65/005; B65H 67/06; B07C 5/18; B65H 2515/10

(57) ABSTRACT

A filament coiling device is provided. The filament coiling device includes: an automatic winding mechanism configured to drive a filament reel to rotate; an automatic filament arranging mechanism disposed opposite to the automatic winding mechanism and configured to automatically thread a front end of a filament into a bottom hole of the filament reel and guide the filament to be wound around the filament reel in a preset filament arranging manner; an automatic tail filament cutting and fixing mechanism disposed on the automatic winding mechanism and configured to cut off a tail end of the filament that has been wound and fix the tail end of the filament to the filament reel; and an automatic loading and unloading mechanism configured to convey and mount a filament reel not wound with a filament to the automatic winding mechanism and transfer the filament reel wound with a filament for storage.

### RELATED APPLICATIONS

The present patent claims the benefit of priority of CN 2023113088490, filed Oct. 10, 2023, which is hereby incorporated by reference in its entirety.

### TECHNICAL FIELD

The present application relates to the technical field of production of three-dimensional (3D) printing consumables, and in particular, to a filament coiling device.

### BACKGROUND

As a rapid prototyping technology, 3D printing is also referred to as additive manufacturing, is a technology that uses such bondable materials as powdered metal or plastic to construct objects based on digital model files by printing layer by layer.

A 3D printing filament is usually produced by an extrusion process. After the extrusion of a filament, the filament needs to be wound around a filament reel to facilitate transportation and use of the filament.

In an existing filament winding process, a plurality of steps need to be completed by manual work, such as replacing a filament reel, and fixing a filament to a bottom hole of a filament reel. Consequently, the production efficiency is low, and there may be product quality problems caused by manual incorrect operations.

### SUMMARY

The present application provides a filament coiling device that can realize automatic online winding of a 3D printing filament, thereby improving the production efficiency and reducing manual work involved, and avoiding product quality problems caused by manual incorrect operations.

To achieve the above objective, embodiments of the present application adopt the following technical solution.

In a first aspect, an embodiment of the present application provides a filament coiling device configured to automatically wind a filament around a filament reel and including:

an automatic winding mechanism configured to drive the filament reel to rotate;

an automatic filament arranging mechanism disposed opposite to the automatic winding mechanism and configured to automatically thread a front end of the filament into a bottom hole of the filament reel and guide the filament to be wound around the filament reel in a preset filament arranging manner;

an automatic tail filament cutting and fixing mechanism disposed on the automatic winding mechanism and configured to cut off a tail end of the filament that has been wound and fix the tail end of the filament to the filament reel; and

an automatic loading and unloading mechanism configured to convey and mount a filament reel not wound with a filament to the automatic winding mechanism and transfer the filament reel wound with a filament for storage.

The filament coiling device provided by the embodiments of the present application can convey and mount a filament reel not wound with a filament to the automatic winding mechanism by means of the automatic loading and unloading mechanism, automatically fix the filament to the bottom hole of the filament reel by means of a threading mechanism, automatically rotate the filament reel for winding by means of the automatic winding mechanism, automatically evenly arrange the filament on the filament reel by means of the automatic filament arranging mechanism, automatically fix the tail end of the filament to the filament reel after the completion of winding by means of the automatic tail filament cutting and fixing mechanism, and finally convey the filament reel after the completion of winding for storage by means of the automatic loading and unloading mechanism. Thus, the degree of automation of the filament coiling device is increased, thereby improving the filament production efficiency and reducing manual work involved, and avoiding product quality problems caused by manual incorrect operations.

### BRIEF DESCRIPTION OF THE DRAWINGS

To describe the technical solutions in the embodiments of the present application more clearly, the accompanying drawings required for describing the embodiments are briefly described below. Apparently, the accompanying drawings in the following description show merely some embodiments of the present application, and a person of ordinary skill in the art may derive other drawings from these accompanying drawings without creative efforts.

FIG. 1 is a flowchart of winding a filament using a filament coiling device provided by an embodiment of the present application;

FIG. 2 is a top view of an entire filament coiling device provided by an embodiment of the present application;

FIG. 3 is a perspective view of an entire filament coiling device provided by an embodiment of the present application;

FIG. 4 is a structural schematic diagram of a filament reel;

FIG. 5 is a structural schematic diagram of an automatic loading and unloading mechanism in a filament coiling device provided by an embodiment of the present application;

FIG. 6 is a structural schematic diagram of a turnover apparatus in an automatic loading and unloading mechanism;

FIG. 7 is a structural schematic diagram I of an automatic filament arranging mechanism in a filament coiling device provided by an embodiment of the present application;

FIG. 8 is an enlarged view of area E of FIG. 7;

FIG. 9 is a structural schematic diagram Il of an automatic filament arranging mechanism in a filament coiling device provided by an embodiment of the present application;

FIG. 10 is an enlarged view of area F of FIG. 9;

FIG. 11 is an enlarged view of area G of FIG. 9;

FIG. 12 is a structural schematic diagram I of an automatic winding mechanism in a filament coiling device provided by an embodiment of the present application;

FIG. 13 is a structural schematic diagram Il of an automatic winding mechanism in a filament coiling device provided by an embodiment of the present application;

FIG. 14 is an enlarged view of area D of FIG. 13;

FIG. 15 is a structural schematic diagram III of an automatic winding mechanism in a filament coiling device provided by an embodiment of the present application;

FIG. 16 is a cross-sectional structural schematic diagram of FIG. 15;

FIG. 17 is an enlarged view of area B of FIG. 16;

FIG. 18 is an enlarged view of area C of FIG. 16;

FIG. 19 is a structural schematic diagram of an automatic tail filament cutting and fixing mechanism in a filament coiling device provided by an embodiment of the present application;

FIG. 20 is a structural schematic diagram of area H of FIG. 19;

FIG. 21 is a structural schematic diagram of a finished product picking apparatus in a filament coiling device provided by an embodiment of the present application; and

FIG. 22 is a structural schematic diagram of a weighing apparatus and a defective product placement bin in a filament coiling device provided by an embodiment of the present application.

### DETAILED DESCRIPTION

It should be understood that in the description of the present disclosure, orientations or positional relationships indicated by terms such as “above”, “below”, “left”, “right”, “front”, “rear”, “top”, “bottom”, “inside”, “outside”, “vertical”, “horizontal”, “transverse”, “longitudinal” are all based on what are illustrated in the drawings. These terms are mainly intended to better describe the present disclosure and embodiments thereof, rather than to define that the devices or components indicated must have the specific orientation or be constructed and operated in the specific orientation.

Besides, some of the terms mentioned above may be used to indicate other meanings in addition to indicating the orientation or positional relations. For example, the term “upper” may also be used to indicate an attachment relationship or a connection relationship in some cases. Those of ordinary skill in the art may understand specific meanings of these terms in the present disclosure based on a specific situation.

In addition, the meanings of the terms “mount”, “dispose”, and “connect” should be understood in a board sense. For example, “connection” may be a fixed connection, a removable connection, or integration; may be a mechanical connection or an electrical connection; may be a direct connection or an indirect connection implemented by using an intermediate medium; or may be intercommunication between two components, elements or components. Those of ordinary skill in the art may understand specific meanings of the foregoing terms in the present disclosure based on a specific situation.

Linear printing materials, one of 3D printing consumables, come into a variety of types. Especially, with the development of the technology, the types of 3D printing filaments are increasingly diversified. Filaments for 3D printing may typically be produced using an extrusion production line. For example, 3D printing filaments such as polylacticacid (PLA), acrylonitrile butadiene styrene (ABS), polypropylene (PP), polycarbonate (PC), thermoplastic urethane (TPU), and a polyvinyl chloride (PVC) may be produced by the extrusion production line.

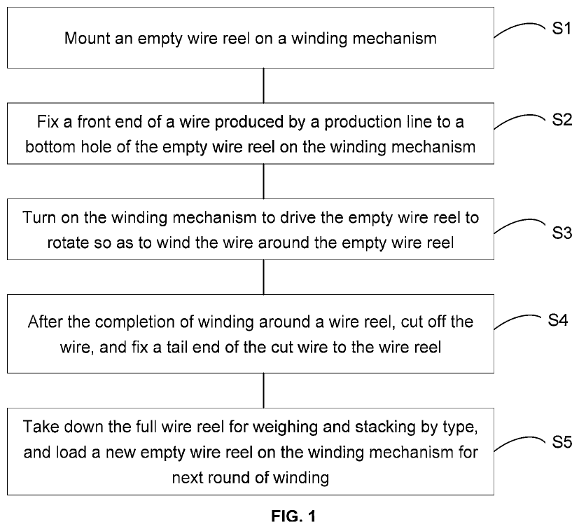

After a filament is extruded by the extrusion production line, the filament needs to be wound around a filament reel to facilitate transportation and use of the filament. As shown in FIG. 1, steps of a winding process for a 3D printing filament are generally as follows.

In step S1, a filament reel not wound with a filament (hereinafter referred to as an empty filament reel) is mounted on an automatic winding mechanism.

In step S2, a front end of a filament produced by the production line is fixed to a bottom hole of the empty filament reel on the automatic winding mechanism.

In step S3, the automatic winding mechanism is turned on to drive the empty filament reel to rotate such that the filament is wound around the empty filament reel.

in step S4, after the completion of winding around a filament reel, the filament is cut off, and a tail end of the cut filament is fixed to the filament reel.

In step S5, the filament reel wound with a filament (hereinafter referred to as a full filament reel) is weighed and stacked by type, and a new empty filament reel is loaded on the automatic winding mechanism for next round of winding.

The steps of the winding process performed by an existing device need to be performed by manual work. Consequently, the production efficiency is low, and there may be product quality problems caused by manual incorrect operations.

In view of the above, some embodiments of the present application provide a filament coiling device that can realize automatic online winding of a 3D printing filament, thereby improving the production efficiency and reducing manual work involved, and avoiding product quality problems caused by manual incorrect operations.

The present application is described in detail below with reference to the drawings.

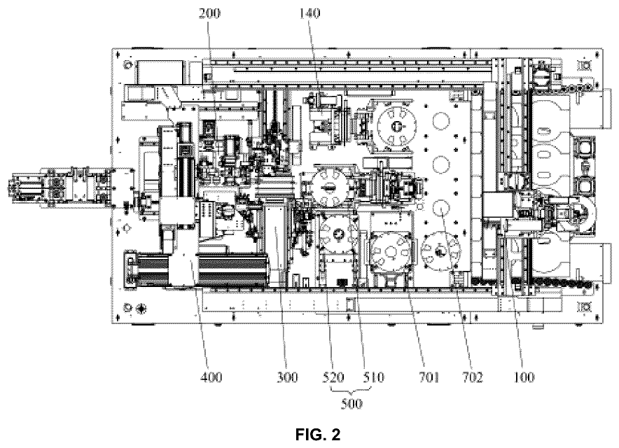

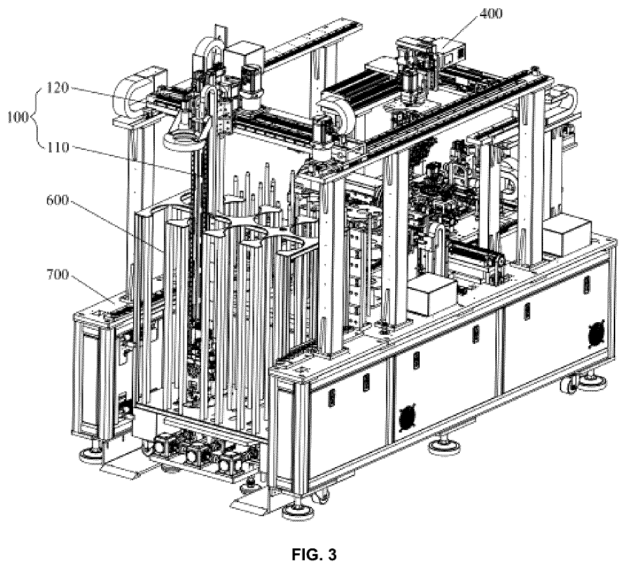

FIG. 2 and FIG. 3 illustrate a filament coiling device. The filament coiling device includes an automatic loading and unloading mechanism 100, an automatic filament arranging mechanism 200, an automatic winding mechanism 300, an automatic tail filament cutting and fixing mechanism 400, and an automatic finished product picking and weighing mechanism 500. The automatic loading and unloading mechanism 100 is configured to convey an empty filament reel and a full filament reel, and load the empty filament reel in the automatic winding mechanism 300, as described in above step S1. The automatic filament arranging mechanism 200 is configured to perform step S2 and automatically threads a front end of a filament into a bottom hole 804 of a filament reel 800 and fixes the front end. The automatic winding mechanism 300 is configured to perform step S3 and drives the filament reel 800 to rotate. Meanwhile, the automatic filament arranging mechanism 200 is configured to adjust a winding position of the filament on the filament reel 800 such that the filament is wound around the filament reel 800 in a preset filament arranging manner. The above-mentioned preset filament arranging manner may be selected according to an actual situation. For example, the filament is arranged from a left end to a right end of the filament reel and then from the right end to the left end. Alternatively, the filament may be arranged first from the right end to the left end of the filament reel and then from the left end to the right end of the filament reel. The filament may also be arranged from a middle of the filament reel, first towards the left end and then towards the right end, etc. The automatic tail filament cutting and fixing mechanism 400 is configured to perform step S4, i.e., cutting off a tail end of the filament that has been wound and fixing the tail end of the filament to the filament reel 800. The automatic finished product picking and weighing mechanism 500 is configured to perform step S5, i.e., taking down and weighing the full filament reel. The automatic loading and unloading mechanism 100 may be further configured to perform the latter part of step S5, i.e., piling up the weighed full filament reel by type. The above steps may be automatically completed, thereby improving the filament production efficiency and reducing manual work involved, and avoiding the product quality problems caused by manual incorrect operations.

In addition to the above-mentioned mechanisms, as shown in FIG. 3, the filament coiling device may further include a delivery and storage device 600 for holding a filament reel 800, a rack 700 for supporting the whole device, and the like. The delivery and storage device 600 may be configured to holding empty filament reels and full filament reels in a stacking manner.

A possible structure of the filament reel 800 is as shown in FIG. 4. The filament reel 800 may include a winding roller 801 and limiting baffles 802 disposed on two sides of the winding roller 801. The winding roller 801 is configured to wind a filament. The limiting baffles 802 are configured to limit the filament wound around the winding roller 801 to prevent the filament from unwinding from two ends of the winding roller 801. A central hole 803 is formed in a middle of the winding roller 801 along an axial direction. The central hole 803 penetrates through the limiting baffles 802 at the two sides of the winding roller 801. The central hole 803 may be configured for the automatic loading and unloading mechanism 100 to clamp the filament reel 800, and may also be configured for the automatic winding mechanism 300 to locate the filament reel 800 during winding. The bottom hole 804 of the filament reel 800 is formed in a sidewall of the winding roller 801 and communicated with the central hole 803. The bottom hole 804 is configured for fixation with an end of a filament such that the filament is preliminarily positioned with the filament reel 800 before winding.

The mechanisms of the filament coiling device are separately described in detail in conjunction with the winding process described above.

Before step S1 is performed, empty filament reels may be stacked in a storage bin of the delivery and storage device 600 along the vertical direction, and then the delivery and storage device 600 full of empty filament reels are moved to a pick-up station of the filament coiling device, and the delivery and storage device 600 is limited such that the delivery and storage device 600 is prevented from moving in a pick-and-place process.

The automatic loading and unloading mechanism 100 is configured to perform step S1. The automatic loading and unloading mechanism 100 moves to be above the delivery and storage device 600, picks up the filament reel 800 along a vertical direction, and then moves to the automatic winding mechanism 300. As shown in FIG. 3, the automatic loading and unloading mechanism 100 includes a pick-and-place apparatus 110 and a moving apparatus 120. The pick-and-place apparatus 110 is configured to pick up or place the filament reel 800, and the direction where the filament reel 800 is picked up and placed may be the vertical direction. The moving apparatus 120 is connected with the pick-and-place apparatus 110 so as to drive the pick-and-place apparatus 110 to move within a horizontal plane to convey the filament reel 800.

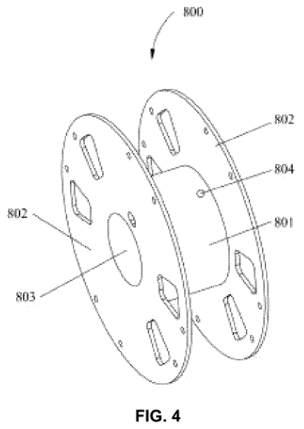

In a use scenario, a placement state of the filament reel 800 in the delivery and storage device 600 is horizontal placement, and a mounting state of the filament reel 800 on the automatic winding mechanism 300 is vertical mounting. Therefore, after the filament reel 800 is picked up by the delivery and storage device 600, the automatic loading and unloading mechanism 100 needs to turn over the filament reel 800 to a vertical state and then mount it on the automatic winding mechanism 300. In order to implement the above-mentioned process, as shown in FIG. 5, the pick-and-place apparatus 110 includes a first clamping assembly 111, a rotating assembly 112, and a vertical moving assembly 113, where the first clamping assembly 111 is configured to clamp the filament reel 800; the rotating assembly 112 is configured to drive the first clamping assembly 111 to rotate such that the filament reel 800 is rotated from a horizontal state to the vertical state; and the vertical moving assembly is configured to drive the first clamping assembly 111 to move along the vertical direction to lift or put down the filament reel 800, or to adjust a position of the filament reel 800 in the vertical direction when mounting the filament reel 800 on the automatic winding mechanism 300.

The first clamping assembly 111 may clamp the filament reel 800 by means of an outer circumference of the filament reel 800, or may clamp the filament reel 800 by means of the central hole 803 of the filament reel 800, or may also clamp the filament reel 800 along a thickness direction of the filament reel 800. Specifically, a clamping manner may be selected according to the state of the filament reel 800 in the delivery and storage device 600. As shown in FIG. 5, the first clamping assembly 111 may extend into the central hole 803 of the filament reel 800 and be relatively fixed to an inner wall of the central hole 803 of the filament reel 800 in an expanding support manner, and may clamp the filament reel 800 through the central hole 803 of the filament reel 800.

Specifically, the first clamping assembly 111 may be implemented in such a manner that a clamping jaw is driven by a cylinder to expand. The rotating assembly 112 may be implemented using a rotating motor. The moving apparatus 120 may be implemented using a truss guide rail in coordination with a linear transmission mechanism as shown in FIG. 5, e.g., in a transmission manner of a motor driving a gear and a rack, in a transmission manner of a motor driving a lead screw and a nut, or in other linear driving manners such as using a linear cylinder and using a linear motor.

In some particular use scenarios, front and reverse sides of the filament reel 800 may be distinguished, and the filament reel may be mounted on the automatic winding mechanism 300 in a preset attitude. Mounting the filament reel 800 in the preset attitude refers to mounting the filament reel 800 such that a predetermined end face thereof faces the automatic winding mechanism 300. For example, when a filament is arranged on the filament reel 800, in order to enable filament arranging from one end of the filament reel 800, the bottom hole 804 of the filament reel 800 is usually set in proximity to a first end face or a second end face of the filament reel 800. Thus, when an empty filament reel is mounted each time, in order to guarantee that each mounted empty filament reel has its bottom hole 804 in a same position in an axial direction, the front and reverse sides of the empty filament reel need to be identified and adjusted.

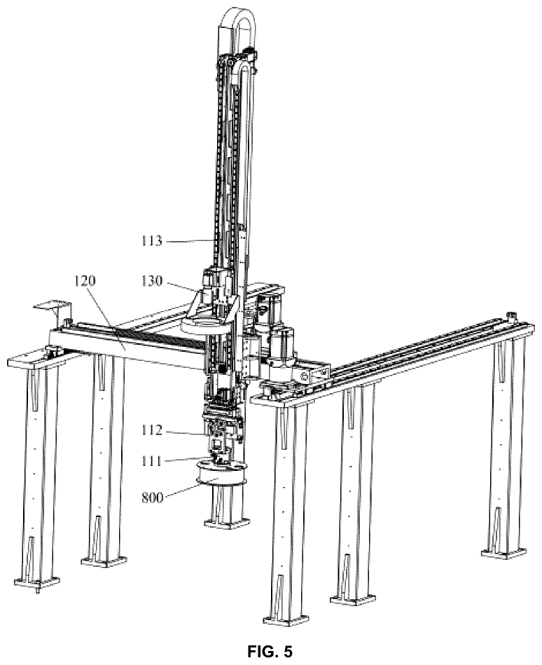

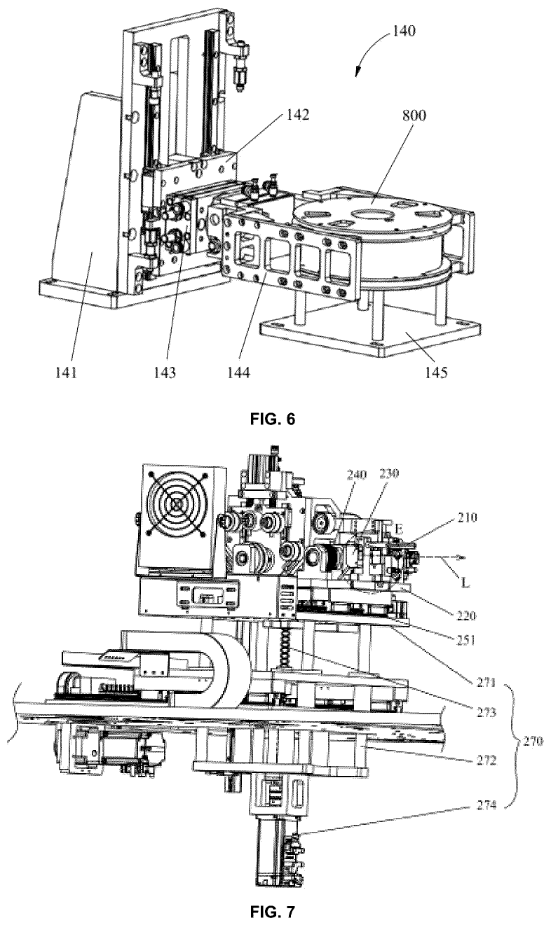

In order to automatically achieve the above-mentioned step of distinguishing and adjusting the front and reverse sides of the filament reel 800, as shown in FIG. 5 and FIG. 6, the automatic loading and unloading mechanism 100 further includes an identification apparatus 130 and a turnover apparatus 140. The identification apparatus 130 is configured to identify the front and reverse sides of the filament reel 800. The identification apparatus 130 may be mounted on the pick-and-place apparatus 110 and move along with the pick-and-place apparatus 110. When the pick-and-place apparatus 110 picks up the filament reel 800, the identification apparatus 130 may identify the front and reverse sides of the filament reel 800. After the identification apparatus 130 completes the identification, a control system determines whether the filament reel 800 needs to be turned over according to an identification result. If yes, the filament reel 800 is conveyed to the turnover apparatus 140 to be turned over. If no, the filament reel 800 is directly conveyed to the automatic winding mechanism 300. The turnover apparatus 140 can turn over the filament reel 800 such that a preset surface thereof (such as the front side or the reverse side) faces upwards according to identification information of the identification apparatus 130. It needs to be noted that the above-mentioned front and reverse sides are merely two definitions intended to distinguish between two end faces of the filament reel 800. The structures of the front and reverse sides may be the same or different, which will not be limited here.

The identification apparatus 130 may be a camera, a scanner, or the like. An identification mark may be disposed on the front side and/or the reverse side of the filament reel 800 such that the identification apparatus 130 identifies the front and reverse sides of the filament reel 800 by photographing or scanning the identification mark. When the identification apparatus 130 is the camera, a charge coupled device (CCD) camera may be used.

As shown in FIG. 6, the turnover apparatus 140 includes a fixed support 141, a lifting support 142, a rotating support 143, and a second clamping assembly 144, where the fixed support 141 is disposed fixedly; and the lifting support 142 is slidably disposed on the fixed support 141 so that it can vertically move relative to the fixed support 141. The rotating support 143 is rotatably disposed on the lifting support 142 and the second clamping assembly 144 is disposed on the rotating support 143 so that the rotating support 143 can drive the second clamping assembly 144 to rotate to turn over the filament reel 800. A filament reel support 145 for holding the filament reel 800 may be disposed beside the turnover apparatus 140. After the first clamping assembly 111 places the filament reel 800 on the filament reel support 145, the second clamping assembly 144 is driven by the lifting support 142 to clamp the filament reel 800 and driven by the rotating support 143 to turn over the filament reel 180° and then place the filament reel back to the filament support 145 such that the preset surface of the filament reel 800 faces upwards. At this point, the first clamping assembly 111 clamps the filament reel 800 again and turns it 90°, and then mounts the filament reel 800 on a driving shaft 320 of the automatic winding mechanism 300.

After an empty filament reel is mounted to the automatic winding mechanism 300, the automatic filament arranging mechanism 200 coordinates with the automatic winding mechanism 300 to perform step S2, where the automatic filament arranging mechanism 200 detects the bottom hole 804 of the filament reel 800 and automatically threads a front end of a filament into the bottom hole 804 of the filament reel 800. The automatic winding mechanism 300 holds down the filament threaded into the bottom hole 804 of the filament reel 800. The end of the filament is thus prevented from coming out of the bottom hole 804 in the winding process.

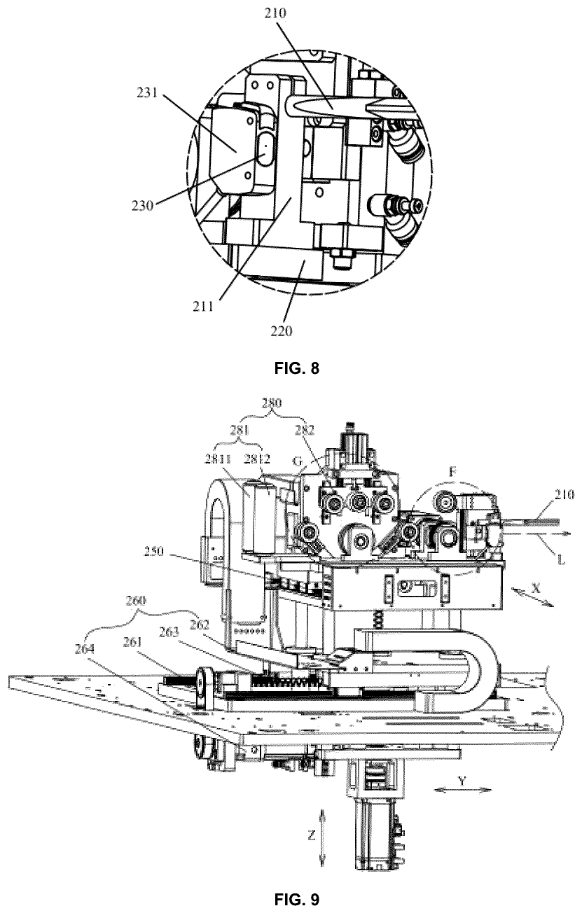

As shown in FIG. 7 and FIG. 8, the automatic filament arranging mechanism 200 includes a filament feeding nozzle 210, a carrying platform 220, and a carrying platform 220 driving apparatus. The filament feeding nozzle 210 is disposed on the carrying platform 220 and configured to guide a conveying direction of the filament. The carrying platform 220 driving apparatus is connected with the carrying platform 220 and configured to drive the carrying platform 220 to move to change a position of the filament feeding nozzle 210 relative to the automatic winding mechanism 300.

As shown in FIG. 7, a bottom hole detection apparatus 230, a control apparatus (not shown in the figure), and an active filament feeding apparatus 240 are further disposed on the carrying platform 220. The bottom hole detection apparatus 230 can automatically detect a position of the bottom hole 804 of the filament reel 800 on the automatic winding mechanism 300. The control apparatus can control the carrying platform 220 to drive the filament feeding nozzle 210 to move when the bottom hole detection apparatus 230 has detected the position of the bottom hole 804, such that a filament feeding direction of the filament feeding nozzle 210 faces the bottom hole 804.

The bottom hole detection apparatus 230 is implemented in a plurality of ways, e.g., by using a reflective photoelectric sensor. The reflective photoelectric sensor is simple in structure, convenient to use, and high in detection accuracy. Specifically, the reflective photoelectric sensor may include an infrared reflective photoelectric sensor, a laser reflective photoelectric sensor, or an ultrasonic reflective photoelectric sensor, etc.

When the reflective photoelectric sensor is used, a light-exiting direction of the reflective photoelectric sensor may be set towards the filament reel 800 on the automatic winding mechanism 300 such that an emitter in the reflective photoelectric sensor emits detection light towards the filament reel 800. In the rotation process of the filament reel 800, when the detection light is irradiated on the winding roller 801 of the filament reel, the detection light is reflected by the winding roller 801 and then is received by a receiver in the reflective photoelectric sensor. If the receiver receives reflected light signals continuously, the bottom hole is not detected. When the detection light passes through the bottom hole 804, the detection light goes out through the bottom hole, and the receiver in the reflective photoelectric sensor cannot receive a reflected light signal. At this point, the control apparatus determines that the bottom hole detection apparatus 230 has detected the position of the bottom hole 804. At this point, the control apparatus may control the automatic winding mechanism 300 to stop rotating such that the filament reel 800 stops in a current position. A relative position of the filament feeding nozzle 210 and the reflective photoelectric sensor may be preset. At this point, the filament feeding nozzle 210 is controlled to move to the position of the reflective photoelectric sensor such that the filament feeding direction of the filament feeding nozzle 210 is aligned to the bottom hole 804.

As shown in FIG. 9, the reflective photoelectric sensor may be disposed in a first preset position and the filament feeding nozzle 210 may be disposed in a second preset position, and a light-exiting direction of the detection light L from the reflective photoelectric sensor is parallel to the filament feeding direction of the filament feeding nozzle 210. In addition, since the automatic loading and unloading mechanism 100 mounts the filament reel 800 on the automatic winding mechanism 300 in the preset attitude, the position of the bottom hole 804 of each filament reel 800 in the axial direction of the filament reel 800 is fixed. At this point, when an initial position (i.e., the first preset position) of the reflective photoelectric sensor is set, it may be set to correspond to the position of the bottom hole 804 in the axial direction of the filament reel 800. That is, an irradiation position of the detection light on the filament reel 800 is in a trajectory of rotation of the bottom hole 804 along the filament reel 800. Thus, when the detection light does not pass through the bottom hole 804, the control apparatus controls the automatic winding mechanism 300 to drive the filament reel 800 to rotate continuously. When the detection light passes through the bottom hole 804, the control apparatus controls the automatic winding mechanism 300 to stop rotating and controls the carrying platform 220 to drive the filament feeding nozzle 210 to move from the second preset position to the first preset position such that the filament feeding direction of the filament feeding nozzle 210 faces the bottom hole 804. Since the light-exiting direction of the reflective photoelectric sensor is parallel to the filament feeding direction of the filament feeding nozzle 210, the carrying platform 220 may drive the filament feeding nozzle 210 to translate to the first preset position.

The bottom hole detection apparatus 230 and the filament feeding nozzle 210 may be mounted separately or mounted together. When the bottom hole detection apparatus 230 and the filament feeding nozzle 210 may be mounted together, as shown in FIG. 8, a filament feeding nozzle support 211 and a bottom hole detection apparatus support 231 may be further disposed on the carrying platform 220. The filament feeding nozzle 210 is disposed on the filament feeding nozzle support 211. The bottom hole detection apparatus support 231 is disposed on a side of the filament feeding nozzle support 211, and the bottom hole detection apparatus 230 is disposed on the bottom hole detection apparatus support 231.

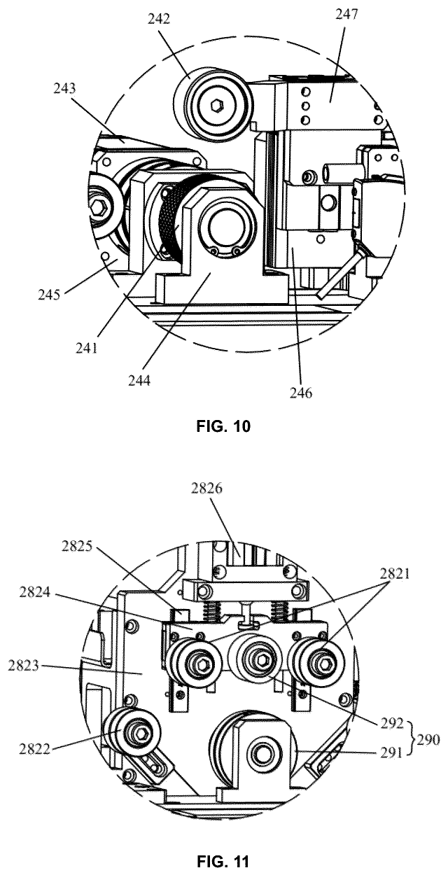

After the filament feeding nozzle 210 is aligned with the bottom hole 804 of the filament reel 800 on the automatic winding mechanism 300, the active filament feeding apparatus 240 provides an active conveying force for the filament such that the front end of the filament is fed into the bottom hole 804 of the filament reel 800. As shown in FIG. 10, the active filament feeding apparatus 240 includes a driving wheel 241, a first hold-down wheel 242, a driving wheel actuator 243, and a first hold-down wheel 242 actuator (not shown in the figure). The driving wheel 241 is fixed relative to the carrying platform 220. The first hold-down wheel 242 is disposed opposite to the driving wheel 241 in the vertical direction and is movable relative to the driving wheel 241 along the vertical direction. The driving wheel actuator 243 is configured to drive the driving wheel 241 to rotate. The filament passes between the first hold-down wheel 242 and the driving wheel 241, and the first hold-down wheel 242 actuator drives the first hold-down wheel 242 to move down to hold down the filament. The driving wheel actuator 243 drives the driving wheel 241 to rotate for conveying the filament forwards by a frictional force between the first hold-down wheel 242 and the driving wheel 241 such that the front end of the filament is threaded into the bottom hole 804. In order to increase a frictional force between the driving wheel 241 and the filament, a surface of the driving wheel 241 may be provided with skidproof stripes. The skidproof stripes may be of a gridded or line structure. Thus, the conveying force provided by the driving wheel 241 to the filament can be more stable, preventing slippage during filament feeding.

When the active filament feeding apparatus 240 is mounted on the carrying platform 220, the structure shown in FIG. 10 may be used. A driving wheel holder 244 is disposed on the carrying platform 220. A rotating shaft of the driving wheel 241 is rotatably connected to the driving wheel 241 holder. An actuator holder 245 is further disposed on the carrying platform 220, and the driving wheel actuator 243 is disposed on the actuator holder 245.

A mounting manner of the first hold-down wheel 242 on the carrying platform 220 is as shown in FIG. 10. A hold-down wheel holder 246 is disposed on the carrying platform 220. A slidable hold-down wheel moving frame 247 is disposed on the hold-down wheel holder 246. The first hold-down wheel 242 is disposed on the hold-down wheel moving frame 247 and located above the driving wheel 241. The first hold-down wheel 242 actuator is connected with the hold-down wheel moving frame 247 such that the hold-down wheel moving frame 247 is driven to move along the vertical direction.

It needs to be noted that the active filament feeding apparatus 240 only needs to provide an active conveying force for a filament when the filament is threaded into the bottom hole 804 of an empty filament reel. After the filament enters the bottom hole 804 of the filament reel 800, the automatic winding mechanism 300 may drive the empty filament reel to rotate, and therefore, the automatic winding mechanism 300 provides the active conveying force for the filament. At this point, the active filament feeding apparatus 240 may be turned off.

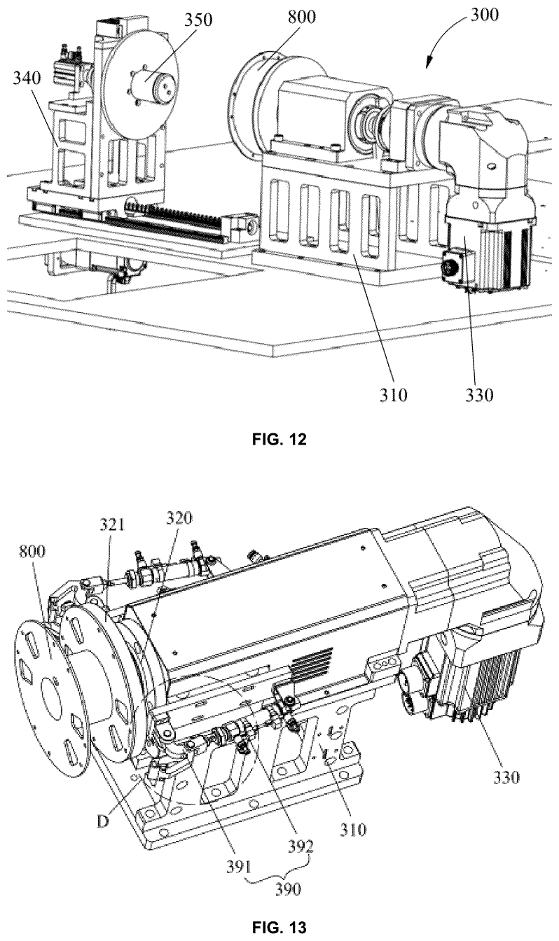

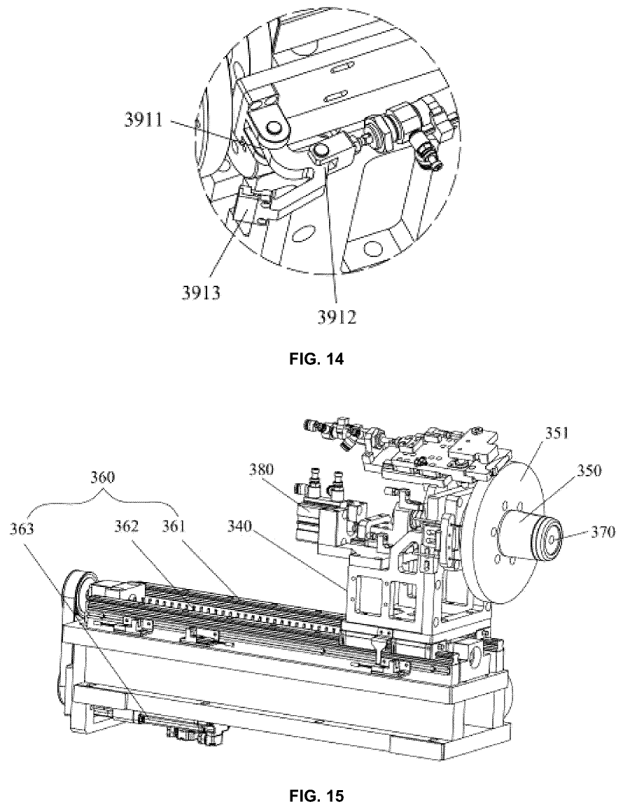

After the front end of the filament is threaded into the bottom hole 804, in order to prevent the filament from coming out of the bottom hole 804, the front end of the filament threaded into the bottom hole 804 may be held down by the automatic winding mechanism 300. As shown in FIG. 12 and FIG. 13, the automatic winding mechanism 300 includes a fixed base 310, a driving shaft 320, a driving shaft actuator 330, and a filament hold-down apparatus, where the fixed base 310 is fixedly disposed on the rack 700; the driving shaft 320 is disposed on the fixed base 310; the driving shaft actuator 330 is configured to drive the driving shaft 320 to rotate; and the filament hold-down apparatus is disposed relative to the driving shaft 320. When the automatic loading and unloading mechanism 100 mounts the filament reel 800 on the automatic winding mechanism 300, firstly, a first end of the central hole 803 of the filament reel 800 is sleeved on the driving shaft 320, and then the automatic loading and unloading mechanism 100 releases the filament reel 800. The filament hold-down apparatus extends into the filament reel 800 through a second end of the central hole 803 to hold down the filament threaded into the bottom hole 804 of the filament reel 800.

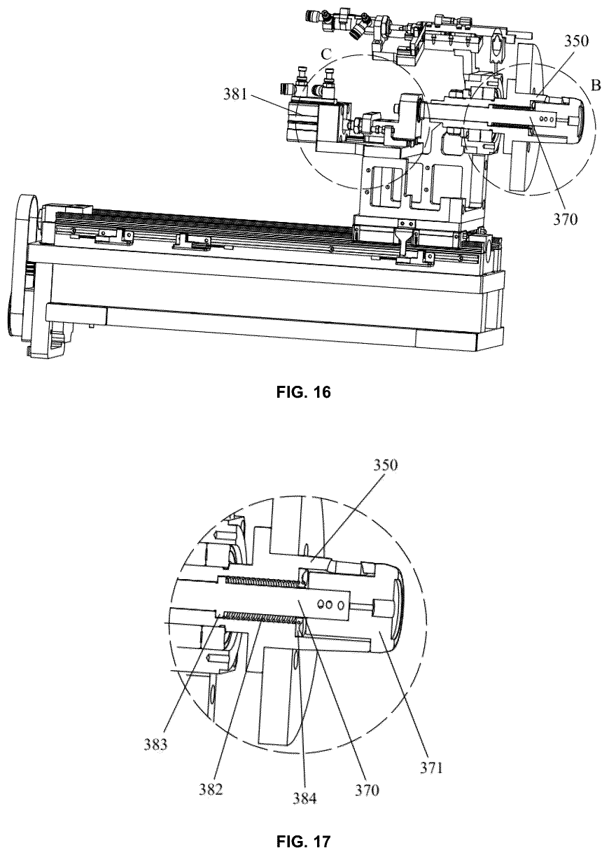

As shown in FIG. 12 and FIG. 15, the filament hold-down apparatus includes a moving base 340 disposed relative to the fixed base 310. The moving base 340 can move along the axial direction of the driving shaft 320. An accessory shaft 350 is disposed on the moving base 340. The accessory shaft 350 is disposed coaxially with the driving shaft 320. The accessory shaft 350 and the moving base 340 may be supported and connected by a bearing. When an actuator drives the driving shaft 320 to rotate, the driving shaft 320 drives the accessory shaft 350 to rotate by means of a frictional force with the filament reel 800. The accessory shaft 350 is connected with an accessory shaft moving assembly 360. The accessory shaft moving assembly 360 can drive the accessory shaft 350 to move along the axial direction of the driving shaft 320 such that the accessory shaft 350 extends into or moves out of the second end of the central hole 803. As shown in FIG. 15 and FIG. 16, the accessory shaft 350 has an axial through hole. A filament hold-down shaft 370 passes through an axial through hole of the accessory shaft 350 and can slide along the axial direction relative to the accessory shaft 350. The filament hold-down shaft 370 is connected with a filament hold-down shaft driving assembly 380. The filament hold-down shaft driving assembly 380 may drive the filament hold-down shaft 370 to slide along the axial direction of the accessory shaft 350 to extend out of or retract into the accessory shaft 350. When the filament hold-down shaft 370 extends out of the accessory shaft 350, the filament hold-down shaft 370 holds down the filament threaded into the bottom hole 804. It needs to be noted that the filament hold-down shaft 370 may hold down the filament on the driving shaft 320.

The accessory shaft moving assembly 360 may be implemented in a plurality of ways as long as it can drive the accessory shaft 350 to move along a straight line. For example, a lead screw-nut assembly, a gear-rack assembly, a linear cylinder, a linear motor, and the like may be used. As shown in FIG. 15, the accessory shaft moving assembly 360 includes an accessory shaft guide rail 361, and a lead screw-nut assembly configured to drive the moving base 340 to slide along the accessory shaft guide rail 361. The accessory shaft guide rail 361 is disposed along the axial direction of the driving shaft 320. The moving base 340 is slidably connected with the accessory shaft guide rail 361. The lead screw-nut assembly includes an accessory shaft lead screw 362, an accessory shaft 350 nut (not shown in the figure), and an accessory shaft motor 363. The accessory shaft lead screw 362 is disposed in parallel to the accessory shaft guide rail 361. The accessory shaft 350 nut is fixed to the moving base 340 and in screw thread fit with the accessory shaft lead screw 362. The accessory shaft motor 363 is in transmission connection with the accessory shaft lead screw 362 to drive the accessory shaft lead screw 362 to rotate.

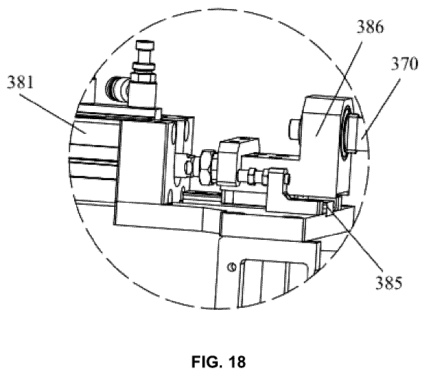

The filament hold-down shaft driving assembly 380 may be implemented in a plurality of ways as long as it can drive the filament hold-down shaft 370 to extend and retract relative to the accessory shaft 350. In an implementation, as shown in FIG. 17 and FIG. 18, the filament hold-down shaft driving assembly 380 includes a filament hold-down cylinder 381. A piston rod of the filament hold-down cylinder 381 is connected with the filament hold-down shaft 370 so as to drive the filament hold-down shaft 370 to slide along the axial direction of the accessory shaft 350. In order to keep the filament hold-down shaft 370 in a retracted state when not holding down a filament, a resetting component 382 may be further provided. The resetting component 382 is connected with the filament hold-down shaft 370 to apply a resetting force for keeping the retracted state to the filament hold-down shaft 370. Specifically, elastic components such as a spring and an elastic piece may be selected to implement the resetting component 382.

When the resetting component 382 is the spring, a mounting structure of the resetting component 382 is as shown in FIG. 17. A spring accommodating cavity is disposed between the accessory shaft 350 and the filament hold-down shaft 370. A first locating portion 383 is disposed on an outer wall of the filament hold-down shaft 370 and a second locating portion 384 is disposed on an inner wall of the accessory shaft 350, and the second locating portion 384 is located on an outer side (i.e., the side close to the driving shaft 320) of the first locating portion 383. The spring accommodating cavity is located between the first locating portion 383 and the second locating portion 384. The spring is located within the spring accommodating cavity. One end of the spring abuts against the first locating portion 383, and the other end of the spring abuts against the second locating portion 384. The spring is always kept in a compressed state, and a resetting force of the spring keeps the filament hold-down shaft 370 in the retracted state. Thus, the filament hold-down shaft 370 may be prevented from extending out of the accessory shaft 350 or dropping out of an axial through hole of the accessory shaft 350 when not holding down a filament.

In order to guide extending and retracting motion of the filament hold-down shaft 370, as shown in FIG. 18, the filament hold-down shaft driving assembly 380 further includes a filament hold-down shaft guide rail 385 and a filament hold-down shaft sliding support 386. The filament hold-down shaft guide rail 385 is disposed on the moving base 340 and extends along the axial direction of the driving shaft 320. The filament hold-down shaft sliding support 386 is in sliding fit with the filament hold-down shaft guide rail 385 and is connected with the piston rod of the filament hold-down cylinder 381. The filament hold-down shaft 370 is disposed on the filament hold-down shaft sliding support 386. Thus, the filament hold-down shaft 370 may be guided precisely by the filament hold-down shaft guide rail 385 and the filament hold-down shaft sliding support 386 such that the movement of the filament hold-down shaft 370 is steadier.

Since the volume of the filament is small, in order to increase a filament hold-down area and avoid that a filament head is not held down, as shown in FIG. 17, a filament hold-down block 371 may be further disposed at an outer end of the filament hold-down shaft 370. An outer diameter of the filament hold-down block 371 is greater than that of the filament hold-down shaft 370 so as to increase the filament hold-down area and ensure a success rate of holding down the filament. In addition, a material of the filament hold-down block 371 may be an elastic material, such as rubber and nylon, preventing damage to the filament in the filament hold-down process.

After the front end of the filament is threaded into the bottom hole 804 and is held down by the filament hold-down shaft 370, step S3 is performed, and the filament reel 800 is driven by the driving shaft 320 of the automatic winding mechanism 300 to rotate to wind the filament.

The driving shaft actuator 330 is implemented in a plurality of ways as long as it can drive the driving shaft 320 to rotate. For example, the driving shaft actuator 330 may include a driving shaft 320 driving motor and a transmission assembly. The driving shaft 320 driving motor drives, by means of the transmission assembly, the driving shaft 320 to rotate. The transmission assembly is implemented in a plurality of ways, such as a belt transmission assembly, a chain transmission assembly, and a gear transmission assembly. The gear transmission assembly may be a cylindrical gear set or a bevel gear set.

There are a plurality of implementation solutions of allowing the filament reel 800 to rotate along with the driving shaft 320. For example, a transmission structure similar to a key transmission one may be disposed between the filament reel 800 and the driving shaft 320 or between the filament reel 800 and a first hold-down portion 321 so that the filament reel 800 can rotate synchronously along with the driving shaft 320. In addition, the structure shown in FIG. 13 and FIG. 15 may also be used. The first hold-down portion 321 is disposed on the driving shaft 320, and a second hold-down portion 351 is disposed on the accessory shaft 350. When the filament reel 800 needs to be mounted on the driving shaft 320, the filament hold-down apparatus may be moved in a direction away from the driving shaft 320 to leave enough operation space for mounting the filament reel 800. When the filament reel 800 is sleeved on the driving shaft 320, the first hold-down portion 321 abuts against the first end face of the filament reel 800. At this point, the accessory shaft 350 may be driven by the accessory shaft moving assembly 360 to move close to the driving shaft 320, and the second hold-down portion 351 gradually gets close to the first hold-down portion 321 and finally abuts against the second end face of the filament reel 800 such that the first hold-down portion 321 and the second hold-down portion 351 clamp the filament reel 800 along the axial direction of the filament reel 800. The driving shaft actuator 330 is then turned on, and the driving shaft actuator 330 drives the driving shaft 320 to rotate to wind a filament around the filament reel 800. The first end face and the second end face of the filament reel 800 are two end faces arranged along the axial direction of the filament reel 800, respectively, i.e., outer surfaces of the limiting baffles 802 at the two ends of the filament reel 800 in FIG. 4.

The bottom hole 804 of the filament reel 800 may be disposed to avoid the driving shaft 320, thereby avoiding the filament from being blocked by the bottom hole 804 during threading. Since a filament is arranged from one end of the winding roller 801, in order to avoid the bottom hole 804, a length of the driving shaft 320 may be short. However, when the first end of the central hole 803 of the filament reel 800 is sleeved on the driving shaft 320, the automatic loading and unloading mechanism 100 releases the filament reel 800. At this point, since the driving shaft 320 is short, only part of the central hole 803 of the filament reel 800 is sleeved on the driving shaft 320, it may be at the rise of falling. In order to solve the above problem, a filament reel clamping assembly 390 is disposed on a side of the driving shaft 320. The filament reel clamping assembly 390 is configured to clamp the filament reel 800 on the driving shaft 320 on the first hold-down portion 321. Thus, the filament reel 800 may be fixed temporarily before the second hold-down portion 351 clamps the filament reel 800, and therefore, the filament reel 800 may be prevented from falling from the driving shaft 320. After the first hold-down portion 321 and the second hold-down portion 351 simultaneously hold down the filament reel, the filament reel clamping assembly 390 releases the filament reel 800.

As shown in FIG. 13, the filament reel clamping assembly 390 includes a filament reel clamping jaw 391 and a clamping cylinder 392. An end of the clamping cylinder 392 away from the filament reel clamping jaw 391 is hinged to the fixed base 310. The filament reel clamping jaw 391 is disposed on the fixed base 310 and located on a side of the first hold-down portion 321. The clamping cylinder 392 is connected with the filament reel clamping jaw 391 and configured to drive the filament reel clamping jaw 391 to open or close to clamp or release the filament reel 800. As shown in FIG. 13, the filament reel clamping jaw 391 may include a first hinged portion 3911, a second hinged portion 3912, and a clamping portion 3913. The first hinged portion 3911 is hinged to the fixed base 310. The second hinged portion 3912 is hinged to a piston rod of the clamping cylinder 392. The clamping portion 3913 is configured to contact the filament reel 800 to clamp the filament reel 800. When the piston rod of the clamping cylinder 392 extends outwards, the piston rod drives the clamping portion 3913 to rotate around the first hinged portion 3911 in a direction towards the filament reel 800 to clamp the filament reel 800. When the piston rod of the clamping cylinder 392 is retracted, the piston rod drives the clamping portion 3913 to rotate around the first hinged portion 3911 in a direction away from the filament reel 800 to release the filament reel 800.

In the process of the automatic winding mechanism 300 driving the filament reel 800 to rotate for winding, the automatic filament arranging mechanism 200 may be used to arrange a filament. The automatic filament arranging mechanism 200 mainly serves for guiding a filament to change a winding position of the filament on the winding roller 801 such that the filament is arranged more evenly on the winding roller 801 of the entire filament reel 800.

In a winding process, the filament feeding nozzle 210 is driven by the automatic filament arranging mechanism 200 to move to arrange a filament. When the filament is arranged, in order to wind the filament around the winding roller 801 of the entire filament reel 800 evenly, the filament may be arranged along the axial direction of the winding roller 801. Therefore, one role of the carrying platform 220 is to drive the filament feeding nozzle 210 to move along a first horizontal direction (i.e., the axial direction of the filament reel 800 on the automatic winding mechanism 300) such that the filament is evenly arranged on the winding roller 801 along the axial direction.

When the filament is wound around the filament reel 800, with an increasing number of winding layers of the filament, the tension of the filament will increase continuously because the relative position of the filament feeding nozzle 210 and the filament reel 800 remains unchanged. When the tension increases to a certain degree, the cross-sectional area of the filament may be less than a standard value required by a product, and the filament may even be broken. In order to avoid the above problem, a distance between the filament feeding nozzle 210 and the filament reel 800 may be adjusted in real time according to the number of winding layers of the filament around the filament reel 800 such that the tension of the filament remains unchanged. Thus, another role of the moving base 340 is to drive the filament feeding nozzle 210 to move along a second horizontal direction (a horizontal direction perpendicular to the axial direction of the filament reel 800) to adjust the distance between the filament feeding nozzle 210 and the filament reel 800 and to drive the filament feeding nozzle 210 to move along the vertical direction for adjusting a height of the filament feeding nozzle 210 relative to the filament reel 800. Thus, the relative position of the filament feeding nozzle 210 and the filament reel 800 can be adjusted in two dimensions. For example, in a winding process, with an increasing number of winding layers of a filament, the carrying platform driving apparatus drives the carrying platform to move in a direction away from the filament reel so that the length of the filament between the filament feeding nozzle and the filament reel can be always maintained within a preset range.

It needs to be noted that the length of the filament between the filament feeding nozzle 210 and the filament reel 800 refers to the length of the filament that is behind a filament outlet end of the filament feeding nozzle 210 and before being wound around the winding roller. A distance by which the carrying platform driving apparatus drives the carrying platform to move in the direction away from the filament reel 800 may be preset according to the number of winding layers of the filament around the filament reel. For example, it may be preset that the carrying platform correspondingly moves a certain distance in the direction away from the filament reel 800 each time when the number of winding layers is incremented by one.

In addition, in addition to adjusting the distance between the filament feeding nozzle 210 and the filament reel 800, the tension of the filament may also be maintained by adjusting the position of the filament feeding nozzle 210 in the vertical direction. For example, if a tangential point of the filament with the winding roller is located at an upper edge of the winding roller, the filament feeding nozzle 210 may be moved upwards such that the length of the filament between the filament feeding nozzle 210 and the filament reel increases, thereby reducing the tension of the filament. Conversely, if the tangential point of the filament with the winding roller is located at a lower edge of the winding roller, the filament feeding nozzle 210 may be moved downwards such that the length of the filament between the filament feeding nozzle 210 and the filament reel 800 increases, thereby reducing the tension of the filament as well.

In order to meet the above-mentioned motion requirement of the carrying platform 220, as shown in FIG. 7 and FIG. 9, the carrying platform 220 driving apparatus includes an X-axis moving assembly 250, a Y-axis moving assembly 260, and a Z-axis moving assembly 270. The X-axis moving assembly 250 is configured to drive the carrying platform 220 to move along the first horizontal direction (i.e., the axial direction of the filament reel 800 on the automatic winding mechanism 300) to adjust the position of the filament feeding nozzle 210 along the axial direction of the filament reel 800. For example, in a filament arranging process, the X-axis moving assembly 250 drives the carrying platform 220 to reciprocate along the first horizontal direction so that the filament can be wound around the winding roller of the filament reel for a plurality of layers. Moreover, a limiting sensor may also be provided to control a range within which the X-axis moving assembly 250 drives the carrying platform 220 to move along the first horizontal direction such that the range is fit for the length of the winding roller of the filament reel. When the above-mentioned limiting sensor has a counting function, a number of times of the carrying platform 220 reciprocating along the first horizontal direction may also be detected by the limiting sensor, and then the number of winding layers of the filament around the filament reel is calculated, facilitating control of the distance between the filament feeding nozzle 210 and the filament reel.

The Y-axis moving assembly 260 is configured to drive the carrying platform 220 to move along the second horizontal direction to adjust the distance between the filament feeding nozzle 210 and the filament reel 800. The second horizontal direction is perpendicular to the first horizontal direction. Thus, the distance between the filament feeding nozzle 210 and the filament reel may be adjusted in real time such that the tension of the filament is maintained within a preset range in the winding process.

The Z-axis moving assembly 270 is configured to drive the carrying platform 220 to move along the vertical direction to adjust the height of the filament feeding nozzle 210 relative to the filament reel 800. Thus, the tension of the filament may be maintained by adjusting the position of the filament feeding nozzle in the vertical direction.

With the X-axis moving assembly 250, the Y-axis moving assembly 260, and the Z-axis moving assembly 270, the movement of the filament feeding nozzle 210 in X, Y, and Z directions may be achieved. Accordingly, it can be realized that the filament is evenly arranged on the winding roller 801 along a radial direction and the tension of the filament is maintained within the preset range in the filament arranging process.

When a relative position relationship of the carrying platform 220, the X-axis moving assembly 250, the Y-axis moving assembly 260, and the Z-axis moving assembly 270 is set particularly, the X-axis moving assembly 250 may be connected with the carrying platform 220 to drive the carrying platform 220 to move along the first horizontal direction. The Z-axis moving assembly 270 is connected with the X-axis moving assembly 250 to drive the X-axis moving assembly 250 and the carrying platform 220 to rise and fall. The Y-axis moving assembly 260 is connected with the Z-axis moving assembly 270 to drive the Z-axis moving assembly 270, the X-axis moving assembly 250, and the carrying platform 220 to move along the second horizontal direction. Thus, the movement of the filament feeding nozzle 210 in the X, Y, and Z directions may be achieved. It needs to be noted that in addition to the above embodiments, mutual driving relationships of the X-axis moving assembly 250, the Y-axis moving assembly 260, and the Z-axis moving assembly 270 may be permutated and combined arbitrarily. For example, the Y-axis moving assembly 260 is directly connected with the carrying platform 220, and the X-axis moving assembly 250 is connected with the Y-axis moving assembly 260, and the Z-axis moving assembly 270 is connected with the X-axis moving assembly 250.

The X-axis moving assembly 250, the Y-axis moving assembly 260, and the Z-axis moving assembly 270 may be implemented in a plurality of ways as long as they can realize linear driving, e.g., driving by a cylinder, driving by a linear motor, transmission by a motor in coordination with a gear and a rack, transmission by a motor in coordination with a lead screw and a nut, or driving by a linear module.

In the solution shown in FIG. 9, the X-axis moving assembly 250, the Y-axis moving assembly 260, and the Z-axis moving assembly 270 all adopt the solution of transmission by the motor in coordination with the gear and the rack to achieve linear driving.

A filament guiding assembly 280 may be further disposed on the carrying platform 220. The filament guiding assembly 280 may guide the filament to enter the filament feeding nozzle 210 along an extending direction of the filament feeding nozzle 210, thereby avoiding the filament from being bent when entering the filament feeding nozzle 210.

As shown in FIG. 9, the filament guiding assembly 280 may include a first guiding assembly 281 and a second guiding assembly 282 disposed in sequence along the second horizontal direction. The first guiding assembly 281 is configured to limit a position of the filament in the first horizontal direction such that the filament is aligned to the filament feeding nozzle 210 in the first horizontal direction. The second guiding assembly 282 is disposed downstream of the first guiding assembly 281 and configured to limit a position of the filament in the vertical direction such that the filament is aligned to the filament feeding nozzle 210 in the vertical direction. Thus, the conveying direction of the filament may be aligned to an inlet of the filament feeding nozzle 210, preventing the filament from being bent when entering the filament feeding nozzle 210.

A specific structure of the first guiding assembly 281 may be as shown in FIG. 9. The first guiding assembly 281 includes a first guide roller 2811 and a second guide roller 2812. Both of the first guide roller 2811 and the second guide roller 2812 may be disposed along the vertical direction, and the first guide roller 2811 and the second guide roller 2812 are spaced apart along the first horizontal direction. The filament may pass between the first guide roller 2811 and the second guide roller 2812 so that the position of the filament in the first horizontal direction can be limited. When the first guide roller 2811 and the second guide roller 2812 are arranged, a gap between the first guide roller 2811 and the second guide roller 2812 may be aligned to the inlet of the filament feeding nozzle 210 so that the filament can be aligned to the filament feeding nozzle 210 in the first horizontal direction.

A specific structure of the second guiding assembly 282 may be as shown in FIG. 11. The second guiding assembly 282 includes an upper guide wheel group 2821 and a lower guide wheel group 2822, where the upper guide wheel group 2821 includes a plurality of upper guide wheels arranged along the second horizontal direction. The lower guide wheel group 2822 is disposed below the upper guide wheel group 2821. The lower guide wheel group 2822 includes a plurality of lower guide wheels arranged along the second horizontal direction. The filament that has passed through the first guiding assembly 281 may pass between the upper guide wheel group 2821 and the lower guide wheel group 2822 so that the position of the filament in the vertical direction can be limited. When the upper guide wheel group 2821 and the lower guide wheel group 2822 are arranged, a gap between the upper guide wheel group 2821 and the lower guide wheel group 2822 may be aligned to the inlet of the filament feeding nozzle 210 so that the filament can be aligned to the filament feeding nozzle 210 in the vertical direction.

When relative positions of the plurality of upper guide wheels and the plurality of lower guide wheels are set, in order to contact the upper guide wheels and the lower guide wheels with the filament sufficiently, the plurality of upper guide wheels and the plurality of lower guide wheels may be disposed in a staggered manner in the vertical direction. That is, the upper guide wheels are not aligned to the lower guide wheels in the vertical direction, and a projection of the upper guide wheel on the plane of the lower guide wheels is located between two adjacent lower guide wheels. Thus, when the filament passes between the upper guide wheel group 2821 and the lower guide wheel group 2822, the filament may have large contact areas with the upper guide wheels and the lower guide wheels such that the force acting on the filament in the conveying process is more even.

In order to adapt to filaments of different diameters, one of the upper guide wheel group 2821 and the lower guide wheel group 2822 may set as a movable structure. For example, the lower guide wheel group 2822 may be fixed relative to the carrying platform 220 while the upper guide wheel group 2821 is movable relative to the carrying platform 220 along the vertical direction. Thus, when the filament is initially threaded, the upper guide wheel group 2821 may be lifted up first, and after the filament passes between the upper guide wheel group 2821 and the lower guide wheel group 2822, the upper guide wheel group 2821 is put down to hold down the filament. Thus, the filaments of different diameters may be allowed to pass between the upper guide wheel group 2821 and the lower guide wheel group 2822. The universality of the device is improved. In addition, the upper guide wheel group 2821 may also be fixed relative to the carrying platform 220 while the lower guide wheel group 2822 is movable relative to the carrying platform 220 along the vertical direction. Alternatively, both of the upper guide wheel group 2821 and the lower guide wheel group 2822 may be disposed to be movable relative to the carrying platform 220 along the vertical direction.

As shown in FIG. 11, a guide wheel holder 2823 and a guide wheel moving frame 2824 may be disposed on the carrying platform 220, where the guide wheel holder 2823 is fixed relative to the carrying platform 220; the lower guide wheel group 2822 is fixedly disposed on the guide wheel holder 2823; the guide wheel moving frame 2824 is movably disposed on the guide wheel holder 2823 and located above the lower guide wheel group 2822; the guide wheel moving frame 2824 is movable relative to the guide wheel holder 2823 along the vertical direction; and the upper guide wheel group 2821 is disposed on the guide wheel moving frame 2824. The guide wheel moving frame 2824 is further connected with a moving frame actuator which is configured to drive the guide wheel moving frame 2824 to move along the vertical direction.

The moving frame actuator may be implemented in a plurality of solutions, e.g., driving by a cylinder, driving by a linear motor, transmission by a motor in coordination with a gear and a rack, or transmission by a motor in coordination with a lead screw and a nut. Driving by the cylinder is adopted in the solution shown in FIG. 11. The moving frame actuator includes a moving frame guide rail 2825 and a moving frame driving cylinder 2826. The moving frame guide rail 2825 is disposed on the guide wheel holder 2823 along the vertical direction and is in sliding fit with the guide wheel moving frame 2824. The moving frame driving cylinder 2826 is connected with the guide wheel moving frame 2824 to drive the guide wheel moving frame 2824 to move along the vertical direction. Few components are driven by the cylinder. Thus, easy assembling and space saving can be achieved.

In order to accurately adjust the conveying direction of the filament, at least one lower guide wheel in the lower guide wheel group 2822 may be connected with the guide wheel holder 2823 by an adjustable structure such that the position of the lower guide wheel is adjustable in the vertical direction. For example, the lower guide wheels at two ends in the lower guide wheel group 2822 may be connected with the guide wheel holder 2823 by the adjustable structure. Thus, the conveying direction of the filament can be adjusted accurately. Specifically, the adjustable structure includes a guide groove disposed on the guide wheel holder 2823, and a slider and a fastener disposed on the lower guide wheel, where the slider is in sliding fit with the guide groove; and the fastener is switchable between a locked state and an unlocked state. When the fastener is in the locked state, the fastener locks and fixes the lower guide wheel to the guide wheel. When the fastener is in the unlocked state, the lower guide wheel is slidable relative to the guide groove. Specifically, the fastener may be implemented by using a structure such as a screw and a pin.

In a filament winding process, in order to count a winding length of the filament, a metering assembly 290 may be provided. The metering assembly 290 is capable of counting the length of the filament wound around the filament reel 800 such that a filament produced by a production line is counted accurately.

As shown in FIG. 11, the metering assembly 290 may specifically include a metering roller 291, a second hold-down wheel 292, and a rotation detection component (not shown in the figure). The metering roller 291 is disposed in a conveying path of the filament. The second hold-down wheel 292 is disposed opposite to the metering roller 291 in the vertical direction and is movable relative to the metering roller 291 along the vertical direction. The rotation detection component is connected with the metering roller 291 to detect a number of revolutions of the metering roller 291. The filament may pass between the metering roller 291 and the second hold-down wheel 292. When the metering roller 291 and the second hold-down wheel 292 hold down the filament, a frictional force from conveying the filament forwards may drive the metering roller 291 to rotate. Since the metering roller 291 is connected with the rotation detection component, the length of the filament passing through the metering roller 291 may be calculated with the number of revolutions of the metering roller 291 detected by the rotation detection component. The rotation detection component may be a detection instruction such as a rotary encoder.

In order to realize up-and-down movement of the second hold-down wheel 292, a separate actuator may be used to drive the second hold-down wheel 292. For example, a separate cylinder may be employed to drive the second hold-down wheel to move up and down. In addition, as shown in FIG. 11, the second hold-down wheel 292 may also be disposed together with the upper guide wheel group 2821, e.g., both disposed on the guide wheel moving frame 2824, such that the second hold-down wheel 292 and the upper guide wheel group 2821 are driven by the moving frame actuator. Thus, a number of actuators can be reduced, thereby reducing a device cost and narrowing space occupied. In particular, the metering roller 291 may be disposed on the guide wheel holder 2823 and arranged with the plurality of lower guide wheels along the second horizontal direction, and the second hold-down wheel 292 is disposed on the guide wheel moving frame 2824 and arranged with the plurality of upper guide wheels along the second horizontal direction.

When the filament has been wound around the filament reel 800, step S4 may be performed. That is, the filament is cut off and fixed to the filament reel 800 such that a tail filament cutting and fixing process (a process of fixing or tying the tail end of the filament to the filament reel 800) is completed. It needs to be noted that the meaning of the above tail filament may be understood as the tail end of the filament wound around the filament reel 800. After the completion of winding the filament, the tail end of the filament needs to be fixed or tied to the filament reel 800 to prevent the filament wound around the filament reel 800 from unwinding.

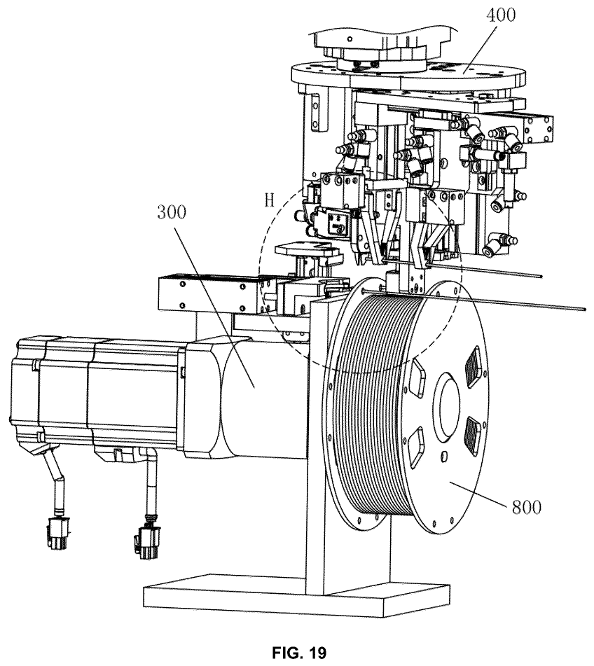

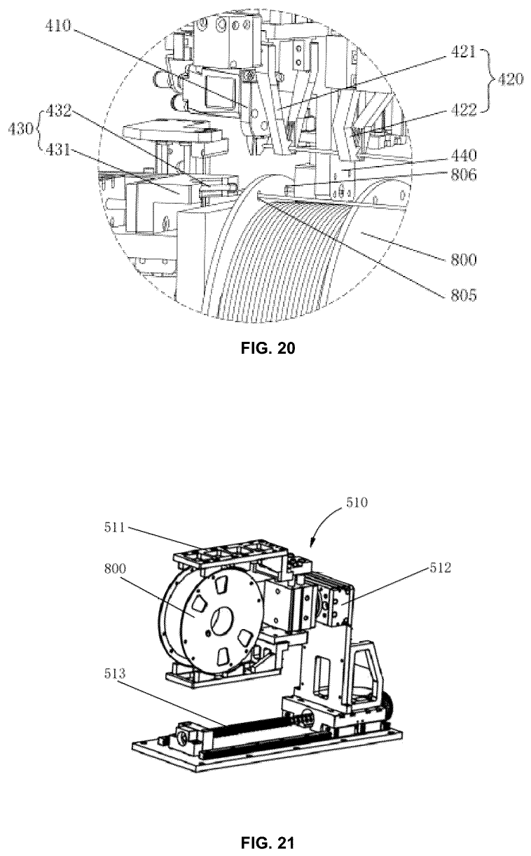

The above-mentioned tail filament cutting and fixing process may be achieved by the automatic tail filament cutting and fixing mechanism 400. As shown in FIG. 19 and FIG. 20, the automatic tail filament cutting and fixing mechanism 400 may be disposed on the automatic winding mechanism 300. The automatic tail filament cutting and fixing mechanism 400 includes a filament cutting module 410 and a threading module. The filament cutting module 410 is configured to automatically cut off an end of the filament that is not wound around the filament reel 800 to form the tail end of the filament after the filament has been wound around the filament reel 800. The threading module is configured to automatically thread the tail end of the filament into a threading hole of the filament reel 800 and fix the tail end.

The filament cutting module 410 may include an automatic shear and a shear driving apparatus. The automatic shear may be automatically opened and closed to cut the filament. The shear driving apparatus may drive the automatic shear to move to a filament cutting position. Specifically, the above-mentioned automatic shear may be a pneumatically driven shear or an electrically driven shear.

In order to fix the tail end of the filament to the filament reel 800 more securely, a first threading hole 805 and a second threading hole 806 are formed in the filament reel 800. The tail end of the filament is sequentially threaded through the first threading hole 805 and the second threading hole 806 and tensioned so that relative fixation of the filament with the filament reel 800 can be achieved. As shown in FIG. 20, the first threading hole 805 and the second threading hole 806 may be disposed on the same side of the filament reel 800. At this point, during threading, the tail end of the filament may be first threaded through the first threading hole 805, and the tail end of the filament is reversed and then threaded into the second threading hole 806, thereby achieving the fixation of the filament relative to the filament reel 800. In order to implement the above-mentioned process, the threading module includes a filament feeding module 420 and a filament guiding mechanism 430. The filament feeding module 420 may automatically thread the tail end of the filament into the first threading hole 805 of the filament reel 800. The filament guiding mechanism 430 is configured to guide the tail end to come out of the second threading hole 806 after passing through the first threading hole 805.

Since the automatic tail filament cutting and fixing mechanism 400 is provided with the filament guiding mechanism 430, the filament guiding mechanism 430 is capable of guiding the tail end to come out of the second threading hole 806 after passing through the first threading hole 805. Therefore, when a filament is threaded, the filament feeding module 420 only needs to feed the filament into the first threading hole 805. After the filament enters the first threading hole 805, the filament is reversed under the action of the filament guiding mechanism 430, and gradually comes out of the second threading hole 806 as it is continuously fed by the filament feeding module 420. Therefore, the fixation of the filament to the filament reel 800 can be achieved more conveniently without a complex threading action by the filament feeding module 420.

The filament guiding mechanism 430 may include a filament guiding groove assembly and a filament guiding groove actuator (not shown in the figure). As shown in FIG. 20, the filament guiding groove assembly includes a base plate 431 and a filament guiding groove 432 formed in a first surface of the base plate 431. A first end of the filament guiding groove 432 faces the first threading hole 805, and a second end of the filament guiding groove 432 faces the second threading hole 806. Thus, after the tail end of the filament passes through the first threading hole 805, the tail end may enter the filament guiding groove 432 through the first end of the filament guiding groove 432, and the filament can be guided by the filament guiding groove 432 to be bent by means of its own flexibility, and to gradually come out of the second end of the filament guiding groove 432 and pass through the second threading hole 806.

The first end of the filament guiding groove 432 facing the first threading hole 805 may be the first end of the filament guiding groove 432 being in direct contact and communication with the first threading hole 805, or may be the first end of the filament guiding groove 432 being opposite to and having a certain gap with the first threading hole 805. Likewise, the second end of the filament guiding groove 432 facing the second threading hole 806 may be the second end of the filament guiding groove 432 being in direct contact and communication with the second threading hole 806, or may be the second end of the filament guiding groove 432 being opposite to and having a certain gap with the second threading hole 806.

The filament guiding groove actuator is configured to drive the filament guiding groove assembly to move towards or away from the filament reel 800. Thus, when the tail filament cutting and fixing process needs to be performed, the filament guiding groove actuator may move the filament guiding groove assembly towards the filament reel 800 such that two ends of the filament guiding groove assembly are communicated with the first threading hole 805 and the second threading hole 806, respectively. After the completion of the tail filament cutting and fixing process, the filament guiding groove actuator may move the filament guiding groove assembly away from the filament reel 800 such that the filament guiding groove assembly is disengaged from the filament and then the filament reel 800 after the completion of winding can be taken down.

It needs to be noted that the filament guiding groove actuator may be any apparatus capable of realizing linear driving, such as a cylinder, a linear motor, or a rotating motor in coordination with a linear transmission mechanism.

The filament feeding module 420 may clamp and convey the filament into the first threading hole 805. The filament feeding module 420 may include a filament clamping module and a filament clamping displacement module. The filament clamping module is configured to clamp a part of the filament close to the tail end. The filament clamping displacement module may drive the filament clamping module to move towards or away from the first threading hole 805 such that the tail end of the filament is threaded into the first threading hole 805 of the filament reel 800.

As shown in FIG. 20, the filament clamping module may include a first filament clamping module 421 and a second filament clamping module 422. The first filament clamping module 421 may be configured to clamp a first part of the filament, and the second filament clamping module 422 may be configured to clamp a second part of the filament. The first part is closer to the tail end of the filament than the second part. The filament clamping displacement module may include a first filament clamping displacement apparatus and a second filament clamping displacement apparatus. The first filament clamping displacement apparatus may drive the first filament clamping module 421 and the second filament clamping module 422 to move as a whole such that the tail end of the filament is threaded into the first threading hole 805. After the tail end of the filament is threaded into the first threading hole 805, the first filament clamping displacement apparatus stops moving and the first filament clamping module 421 releases the filament. At this point, the second filament clamping displacement apparatus may drive the second filament clamping module 422 to reciprocate towards and away from the first threading hole 805 (in this process, the second filament clamping module 422 releases the filament when it is closest to the first threading hole 805 and clamps the filament again when it is farthest away from the first threading hole 805, i.e., performs the threading action). The tail end of the filament comes out of the second threading hole 806 by means of the filament guiding mechanism 430.

The filament feeding module 420 may further include a filament clamping module lifting apparatus configured to drive the first filament clamping module 421 and the second filament clamping module 422 to rise and fall. Thus, when the tail filament cutting and fixing process needs to be performed, the clamping filament module is driven to move to an appropriate position so as to clamp the filament. The filament clamping module lifting apparatus may be implemented by a cylinder, a linear motor, or a rotating motor in coordination with a linear transmission mechanism.

As shown in FIG. 20, a threading module may further include a filament tensioning module 440 to automatically tension the tail end of the filament coming out of the second threading hole 806 for preventing the filament from falling out of the first threading hole 805 and the second threading hole 806.

The filament tensioning module 440 may include a tensioning clamping jaw and a tensioning actuator. The tensioning clamping jaw is disposed on a filament exiting side of the second threading hole 806 to clamp the tail end of the filament coming out of the second threading hole 806. The tensioning actuator may drive the tensioning clamping jaw to move towards or away from the second threading hole 806 to automatically tension the tail end of the filament. The tensioning actuator may be a common actuator such as a cylinder and a motor, which will not be described here redundantly.

It needs to be noted that the front end of the filament refers to a front end portion of a filament output from a production line before the filament is wound, and the tail end of the filament refers to an end portion formed on a wound filament after the filament has been wound around a filament reel 800 and after the wound filament is cut off from the filament on the production line.

After the completion of winding a filament around a filament reel 800, the filament reel 800 may be taken down from the automatic winding mechanism 300, and the filament reel 800 is weighed and classified. Thus, an unaccepted full filament reel not meeting a weight requirement and an accepted full filament reel meeting the weight requirement are screened and distinguished. This process may be automatically completed by using the automatic finished product picking and weighing mechanism 500. As shown in FIG. 2, the automatic finished product picking and weighing mechanism 500 includes a finished product picking apparatus 510 and a weighing apparatus 520. The finished product picking apparatus 510 is configured to take down a full filament reel from the automatic winding mechanism 300 and convey the full filament reel to a weighing station. The weighing apparatus 520 can move to the weighing station and can automatically receive the filament reel 800 conveyed by the finished product picking apparatus 510 and then automatically weigh the filament reel 800.

As shown in FIG. 21, the finished product picking apparatus 510 includes a finished product picking clamping jaw 511, a clamping jaw rotating assembly 512, and a clamping jaw moving assembly 513, where the finished product picking clamping jaw 511 is configured to clamp the filament reel 800; the clamping jaw rotating assembly 512 is configured to drive the finished product picking clamping jaw 511 to rotate such that the vertically disposed filament reel 800 is switched to be horizontally disposed. The horizontally disposed filament reel 800 may be placed on the weighing apparatus 520 more stably without rolling. The clamping jaw moving assembly 513 is configured to drive the clamping jaw rotating assembly 512 and the finished product picking clamping jaw 511 to move to the weighing station so as to place the filament reel 800 to the weighing apparatus 520 for weighing. The clamping jaw rotating assembly 512 may be implemented by using a rotating cylinder or a motor. The clamping jaw moving assembly 513 may be implemented by using a guide rail in coordination with a lead screw and a nut as shown in FIG. 21, which, naturally, may also be implemented by using other linear driving mechanisms.

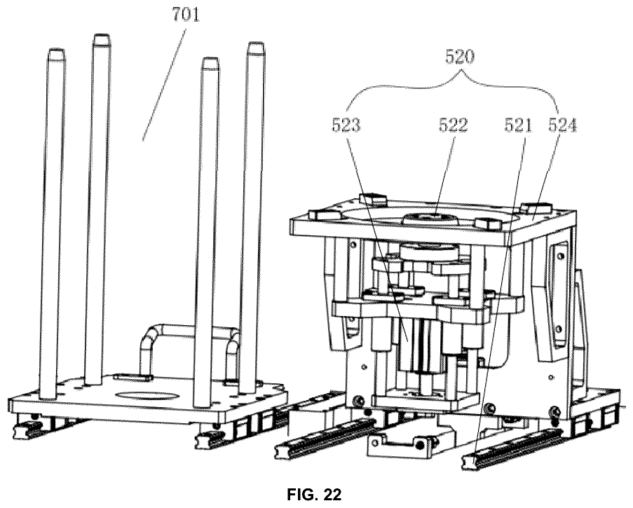

The structure of the weighing apparatus 520 is as shown in FIG. 22. The weighing apparatus 520 is located at the weighing station and may be moved as a whole. After the finished product picking apparatus 510 conveys a full filament reel to the weighing station, the weighing apparatus 520 can move to a position below the finished product picking apparatus 510 along a bottom guide rail 521. In particular, the weighing apparatus 520 may be driven by a linear driving apparatus such as a linear cylinder, a motor in coordination with a lead screw and a nut, or a motor in coordination with a gear and a rack. The weighing apparatus 520 further includes a receiving platform 522, a receiving actuator 523, and a weighing platform 524. The weighing platform 524 is fixed relative to the rack 700. The receiving actuator 523 is configured to drive the receiving platform 522 to move along the vertical direction. When the finished product picking apparatus 510 conveys a full filament reel to the weighing station, the receiving actuator 523 drives the receiving platform 522 to move up to be above the weighing platform 524. At this point, the finished product picking apparatus 510 places the full filament reel on the receiving platform 522, and then the receiving actuator 523 drives the receiving platform 522 to fall until the receiving platform 522 places the full filament reel on the weighing platform 524. The weighing platform 524 is connected with a weighing sensor and thus can automatically weigh the full filament reel.

After the completion of weighing the filament reel 800, the automatic loading and unloading mechanism 100 loads a filament reel 800 having an accepted weight after the completion of winding in the delivery and storage device 600, and loads a filament reel 800 having an unaccepted weight after the completion of winding in a defective product placement bin 701.

In addition, some specific terms in the present disclosure have been used to describe the embodiments of the present disclosure. For example, “one embodiment”, “an embodiment”, and/or “some embodiments” mean that a specific feature, structure, or characteristic described in combination with the embodiment may be included in at least one embodiment of the present disclosure. Therefore, it can be emphasized and should be understood that two or more references to “an embodiment” or “one embodiment” or “an alternative embodiment” in various parts of the present disclosure do not necessarily all refer to the same embodiment. In addition, specific feature, structure, or characteristic may be appropriately combined in one or more embodiments of the present disclosure.

It should be understood that in the foregoing description of the embodiments of the present disclosure, to help understand a feature, and for the purpose of simplifying the present disclosure, the present disclosure sometimes combines various features in a single embodiment, a drawing, or description thereof. However, this does not mean that the combination of these features is necessary. It is entirely possible for those skilled in the art to extract some of the features as a single embodiment for understanding when reading the present disclosure. In other words, the embodiments in the present disclosure can also be understood as an integration of multiple sub-embodiments. The content of each sub-embodiment is also true when it is less than all the characteristics of a single previously disclosed embodiment.

The content in the background section is merely information known to the inventors, and neither represents that the above information has been found in the public field prior to the filing date of the present disclosure nor represents that it can become the prior art of the present disclosure.

Finally, it should be understood that the embodiment of the present disclosure provided herein is an explanation of the principle of the embodiment of the present disclosure. Other modified embodiments are also within the scope of the present disclosure. Therefore, the embodiments disclosed in the present disclosure are merely examples rather than limitations. Those skilled in the art can adopt alternative configurations according to the embodiments in the present disclosure to implement the present disclosure in the present disclosure. Therefore, the embodiments of the present disclosure are not limited to those exactly described in the present disclosure.

What is claimed is:

1. A filament coiling device configured to automatically wind a filament around a filament reel, comprising:
an automatic winding mechanism configured to drive the filament reel to rotate;
an automatic filament arranging mechanism disposed opposite to the automatic winding mechanism and configured to automatically thread a front end of the filament into a bottom hole of the filament reel and guide the filament to be wound around the filament reel in a preset filament arranging manner;
an automatic tail filament cutting and fixing mechanism disposed on the automatic winding mechanism and configured to cut off a tail end of the filament that has been wound and fix the tail end of the filament to the filament reel; and
an automatic loading and unloading mechanism configured to convey and mount a filament reel not wound with a filament to the automatic winding mechanism and transfer the filament reel wound with a filament for storage.

2. The filament coiling device according to claim 1, wherein the automatic filament arranging mechanism includes:
a carrying platform;
a filament feeding nozzle disposed on the carrying platform and configured to guide a conveying direction of the filament; and
a carrying platform driving apparatus connected with the carrying platform and configured to drive the carrying platform to move to change a position of the filament feeding nozzle relative to the filament reel on the automatic winding mechanism.

3. The filament coiling device according to claim 2, wherein the carrying platform driving apparatus includes:
an X-axis moving assembly configured to drive the carrying platform to move along a first horizontal direction to adjust a position of the filament feeding nozzle along an axial direction of the filament reel;
a Y-axis moving assembly configured to drive the carrying platform to move along a second horizontal direction to adjust a distance between the filament feeding nozzle and the filament reel; and
a Z-axis moving assembly configured to drive the carrying platform to move along a vertical direction to adjust a height of the filament feeding nozzle relative to the filament reel.

4. The filament coiling device according to claim 3, wherein the automatic filament arranging mechanism further includes at least one of:
a filament guiding assembly disposed on the carrying platform and configured to guide the filament to enter the filament feeding nozzle along an extending direction of the filament feeding nozzle; or
a metering assembly disposed on the carrying platform and configured to meter a length of the filament wound around the filament reel.

5. The filament coiling device according to claim 4, wherein the filament guiding assembly includes a first guiding assembly and a second guiding assembly disposed in sequence along the second horizontal direction;
the first guiding assembly is configured to limit a position of the filament in the first horizontal direction such that the filament is aligned to the filament feeding nozzle in the first horizontal direction; and
the second guiding assembly is configured to limit a position of the filament in the vertical direction to guide the filament to be aligned to the filament feeding nozzle in the vertical direction.

6. The filament coiling device according to claim 5, wherein the first guiding assembly includes:
a first guide roller configured such that an axial direction of the first guide roller is disposed along the vertical direction; and
a second guide roller configured to be parallel to the first guide roller, wherein the second guide roller and the first guide roller are spaced apart along the first horizontal direction; and the filament passes between the first guide roller and the second guide roller.

7. The filament coiling device according to claim 5, wherein the second guiding assembly includes:
an upper guide wheel group comprising a plurality of upper guide wheels arranged along the second horizontal direction; and
a lower guide wheel group disposed below the upper guide wheel group and comprising a plurality of lower guide wheels, wherein the plurality of lower guide wheels are arranged along the second horizontal direction; and the filament passes between the upper guide wheel group and the lower guide wheel group.

8. The filament coiling device according to claim 7, wherein the carrying platform is provided with:
a guide wheel holder fixed relative to the carrying platform, wherein the lower guide wheel group is fixedly disposed on the guide wheel holder;
a guide wheel moving frame movably disposed on the guide wheel holder and located above the lower guide wheel group, wherein the guide wheel moving frame is movable relative to the guide wheel holder along the vertical direction; and the upper guide wheel group is disposed on the guide wheel moving frame; and
a moving frame actuator connected with the guide wheel moving frame and configured to drive the guide wheel moving frame to move along the vertical direction.

9. The filament coiling device according to claim 4, wherein the metering assembly includes:
a metering roller disposed in a conveying path of the filament;
a second hold-down wheel disposed opposite to the metering roller in the vertical direction and movable relative to the metering roller along the vertical direction to hold down the filament between the metering roller and the second hold-down wheel; and
a rotary encoder connected with the metering roller to detect a number of revolutions of the metering roller.

10. The filament coiling device according to claim 2, wherein the automatic filament arranging mechanism further includes:
a bottom hole detection apparatus configured to detect a position of a bottom hole of the filament reel on the automatic winding mechanism;
a control apparatus configured to, when the bottom hole detection apparatus detects the position of the bottom hole, control the carrying platform to drive the filament feeding nozzle to move such that a filament feeding direction of the filament feeding nozzle faces the bottom hole; and
an active filament feeding apparatus configured to provide an active conveying force for the filament when feeding the filament to feed a front end of the filament through the bottom hole.

11. The filament coiling device according to claim 10, wherein the bottom hole detection apparatus includes a reflective photoelectric sensor; and a light-exiting direction of the reflective photoelectric sensor faces the filament reel on the automatic winding mechanism such that the position of the bottom hole is detected with detection light emitted from the reflective photoelectric sensor; or
the active filament feeding apparatus includes: a driving wheel fixed relative to the carrying platform; a driving wheel actuator configured to drive the driving wheel to rotate; a first hold-down wheel disposed opposite to the driving wheel in the vertical direction; and a first hold-down wheel actuator configured to drive the first hold-down wheel to move along the vertical direction.

12. The filament coiling device according to claim 10, wherein when the bottom hole detection apparatus includes the reflective photoelectric sensor, the reflective photoelectric sensor is located at a first preset position and the filament feeding nozzle is located at a second preset position, and the light-exiting direction of the reflective photoelectric sensor is parallel to the filament feeding direction of the filament feeding nozzle, and an irradiation position of the detection light on the filament reel is in a rotation trajectory of the bottom hole; and
the control apparatus is configured to:
when the detection light does not pass through the bottom hole, control the automatic winding mechanism to drive the filament reel to rotate; and
when the detection light passes through the bottom hole, control the automatic winding mechanism to stop rotating and control the carrying platform to drive the filament feeding nozzle to move from the second preset position to the first preset position such that the filament feeding direction of the filament feeding nozzle faces the bottom hole.

13. The filament coiling device according to claim 1, wherein the automatic winding mechanism includes:
a fixed base;
a driving shaft disposed on the fixed base and configured to be fit and connected with a first end of a central hole of the filament reel;
a driving shaft actuator configured to drive the driving shaft to rotate for driving the filament reel on the driving shaft to rotate to wind the filament; and
a filament hold-down apparatus configured to stretch into a second end of the central hole of the filament reel to hold down the filament threaded into the bottom hole of the filament reel.

14. The filament coiling device according to claim 13, wherein the filament hold-down apparatus includes:
a moving base disposed on a side of the fixed base and movable along an axial direction of the driving shaft;
an accessory shaft disposed on the moving base and disposed coaxially with the driving shaft; and
an accessory shaft moving assembly configured to drive the accessory shaft to move along the axial direction of the driving shaft such that the accessory shaft extends into or moves out of the second end of the central hole;
a filament hold-down shaft passing through the accessory shaft and slidable relative to the accessory shaft along an axial direction; and
a filament hold-down shaft driving assembly connected with the filament hold-down shaft and configured to drive the filament hold-down shaft to slide along the axial direction of the accessory shaft to extend out of or retract into the accessory shaft, wherein when the filament hold-down shaft extends out of the accessory shaft, the filament hold-down shaft holds down the filament threaded into the bottom hole.

15. The filament coiling device according to claim 1, wherein the automatic loading and unloading mechanism includes:
a pick-and-place apparatus configured to pick up or place the filament reel and mount the filament reel on the automatic winding mechanism in a preset attitude;
a moving apparatus connected with the pick-and-place apparatus and configured to drive the pick-and-place apparatus to move within a horizontal plane;
an identification apparatus disposed on the pick-and-place apparatus and configured to identify a front side and a reverse side of the filament reel, wherein an identification mark is disposed on the front side or the reverse side of the filament reel, and the identification apparatus is configured to identify the front side and the reverse side of the filament reel by photographing or scanning the identification mark; and
a turnover apparatus configured to turn over the filament reel with a preset surface facing upwards according to identification information of the identification apparatus.

16. The filament coiling device according to claim 15, wherein the pick-and-place apparatus includes: a first clamping assembly configured to clamp the filament reel; a rotating assembly configured to drive the first clamping assembly to rotate so as to rotate the filament reel from a horizontal state to a vertical state; and a vertical moving assembly configured to drive the first clamping assembly to move along the vertical direction; or
the turnover apparatus includes: a fixed support; a lifting support in sliding fit with the fixed support and configured to be vertically movable relative to the fixed support; a rotating support disposed on the lifting support and configured to be rotatable relative to the lifting support; and a second clamping assembly disposed on the rotating support and configured to clamp the filament reel.

17. The filament coiling device according to claim 1, wherein the automatic tail filament cutting and fixing mechanism includes:
a filament cutting module configured to automatically cut off an end of the filament that is not wound around the filament reel to form the tail end of the filament after the filament has been wound around the filament reel; and
a threading module configured to automatically thread the tail end of the filament into a threading hole of the filament reel and fix the tail end.

18. The filament coiling device according to claim 17, wherein the threading hole includes a first threading hole and a second threading hole; and the threading module includes:
a filament feeding module configured to automatically thread the tail end of the filament into the first threading hole; and
a filament guiding mechanism configured to guide the tail end to go out of the second threading hole after passing through the first threading hole.

19. The filament coiling device according to claim 18, wherein the filament guiding mechanism includes a filament guiding groove assembly and a filament guiding groove actuator; the filament guiding groove assembly includes a base plate and a filament guiding groove formed in a first surface of the base plate; a first end of the filament guiding groove faces the first threading hole, and a second end of the filament guiding groove faces the second threading hole; the filament guiding groove actuator is configured to drive the filament guiding groove assembly to move towards or away from the filament reel; or
the filament feeding module includes: a first filament clamping module configured to clamp a first part of the filament that is close to the tail end of the filament; a second filament clamping module configured to clamp a second part of the filament that is located on a side of the first part away from the tail end of the filament; a first filament clamping displacement apparatus configured to drive the first filament clamping module and the second filament clamping module to move such that the tail end of the filament passes through the first threading hole; and a second filament clamping displacement apparatus configured to, when the first filament clamping module releases the filament, drive the second filament clamping module to reciprocate, such that the tail end of the filament extends out of the second threading hole through the filament guiding mechanism.

20. The filament coiling device according to claim 1, further comprising at least one of:
an automatic finished product picking and weighing mechanism comprising a finished product picking apparatus and a weighing apparatus, wherein the finished product picking apparatus is configured to take down a filament reel after the completion of winding from the automatic winding mechanism and convey the filament reel to a weighing station; and the weighing apparatus is located at the weighing station and configured to receive and weigh the filament reel conveyed by the finished product picking apparatus; or
a delivery and storage device and a defective product placement bin, wherein the delivery and storage device is configured to load a filament reel not wound with a filament and a filament reel having an accepted weight after the completion of winding; the defective product placement bin is configured to hold a filament reel having an unaccepted weight after the completion of winding; and the automatic loading and unloading mechanism is configured to pick up a filament reel not wound with a filament from the delivery and storage device and mount the filament reel to the automatic winding mechanism, load a filament having an accepted weight after the completion of winding to the delivery and storage device, and load a filament reel having an unaccepted weight after the completion of winding to the defective product placement bin.
